(19) United States
(12) Patent Application Publication
(10) Pub. No.: US 2025/0126596 A1
(43) Pub. Date: Apr. 17, 2025

(54) ENABLING ULTRA WIDE BAND OUT-OF-BAND OVER BLUETOOTH AND WI-FI

(71) Applicant: Cisco Technology, Inc., San Jose, CA (US)

(72) Inventors: Jerome HENRY, Pittsboro, NC (US); Matthew A. SILVERMAN, Shaker Heights, OH (US); Robert E. BARTON, Richmond (CA); Peiman AMINI, Fremont, CA (US); Ardalan ALIZADEH, Campbell, CA (US)

(21) Appl. No.: 18/828,949

(22) Filed: Sep. 9, 2024

Related U.S. Application Data
(60) Provisional application No. 63/590,230, filed on Oct. 13, 2023.

(51) Int. Cl. H04W 64/00; H04B 1/7163; H04W 24/02

(52) U.S. Cl. CPC H04W 64/00; H04B 1/7163; H04W 24/02

(57) ABSTRACT

Techniques and apparatus for configuring ultra-wideband (UWB) communications using out-of-band (OOB) mechanisms are described. An example technique performed by a wireless device includes obtaining, prior to association with an access point (AP), ultra-wideband (UWB) information from the AP via an out-of-band (OOB) communication link between the wireless device and the AP. A location server within a network including the wireless device and the AP is determined based on the UWB information. Configuration information associated with a UWB ranging session from the location server is obtained via the OOB communication link. The UWB ranging session is performed in accordance with the configuration information.

### CROSS-REFERENCE TO RELATED APPLICATIONS

This application claims benefit of co-pending U.S. provisional patent application Ser. No. 63/590,230 filed Oct. 13, 2023. The aforementioned related patent application is herein incorporated by reference in its entirety.

### TECHNICAL FIELD

Embodiments presented in this disclosure generally relate to wireless communications. More specifically, embodiments disclosed herein relate to techniques for configuring ultra-wideband (UWB) communications using out-of-band (OOB) mechanisms.

### BACKGROUND

UWB can enable precise real-time measurement of location and distance. UWB can be used to provide client location and/or ranging services with considerably high accuracy (e.g., to within 10 centimeters (cm) in line of sight (LoS) cases, and within 50 cm in non-LoS (NLoS) cases). UWB is defined by the FiRa Consortium, among other organizations. The FiRa technical specifications are based on the High-Rate Pulse Repetition frequency (HRP) portion of the Institute of Electrical and Electronics Engineers (IEEE) 802.15.4-2015 technical specification. Generally, client ranging is performed based on time of flight measurements, which can be performed in two primary ways: two way ranging (TWR) and time difference of arrival (TDoA).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIGS. 2A-2B illustrate an example scenario for configuring UWB using OOB communication, according to certain embodiments.

FIG. 3 is a flowchart of an example method for wireless communications, according to certain embodiments.

FIG. 4 is a flowchart of another example method for wireless communications, according to certain embodiments.

FIG. 5 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a method performed by a wireless device. The method includes obtaining, prior to association with an access point (AP), ultra-wideband (UWB) information from the AP via an out-of-band (OOB) communication link between the wireless device and the AP. The method also includes determining a location server within a network comprising the wireless device and the AP, based on the UWB information. The method also includes obtaining configuration information associated with a UWB ranging session from the location server via the OOB communication link. The method further includes performing the UWB ranging session in accordance with the configuration information.

Another embodiment described herein is a method for wireless communications performed by an access point (AP). The method includes receiving, prior to association with a wireless device, a request message for ultra-wideband (UWB) information from the wireless device via an out-of-band (OOB) communication link between the AP and the wireless device. The method also includes, in response to the request message, obtaining the UWB information from a location server in a network comprising the wireless device and the AP. The method further includes transmitting the UWB information to the wireless device via the OOB communication link.

Another embodiment described herein is a wireless device. The wireless device includes one or more memories collectively storing instructions, and one or more processors communicatively coupled to the one or more memories. The one or more processors are individually or collectively configured to execute the instructions to cause the wireless device to perform an operation. The operation includes obtaining, prior to association with an access point (AP), ultra-wideband (UWB) information from the AP via an out-of-band (OOB) communication link between the wireless device and the AP. The operation also includes determining a location server within a network comprising the wireless device and the AP, based on the UWB information. The operation further includes obtaining configuration information associated with a UWB ranging session from the location server via the OOB communication link. The operation further includes performing the UWB ranging session in accordance with the configuration information.

### EXAMPLE EMBODIMENTS

In certain environments, various devices may use UWB-based techniques to perform positioning (e.g., indoor positioning) for various use cases, such as indoor navigation and location tracking, as illustrative, non-limiting examples. For example, with UWB, devices can transmit data across short distances and precisely determine location by measuring how long it takes for a radio pulse to travel between devices. The spectrum of a UWB packet may extend across 500 megahertz (MHz) of bandwidth, and the UWB packet may include sequences of short duration pulses (e.g., 2 nanosecond (ns) pulses). The short duration pulses and high bandwidth associated with UWB signals may allow UWB devices to precisely keep track of signal transmission times, reception times, and reply times. This, in turn, may allow for precise real-time measurement of location and distance (e.g., within 10 cm in LoS cases and within 50 cm in NLoS cases).

One potential drawback associated with implementing UWB-based techniques is that, prior to UWB ranging, configuration parameters (e.g., session ID among other parameters) generally have to be pre-configured (or set) on the devices (e.g., the initiator and the responder) that will participate in the UWB ranging procedure. In certain embodiments described herein, an out-of-band (OOB) mechanism is used to deliver configuration parameters to the devices that will participate in the UWB ranging procedure. The configuration parameters can be delivered from a controller, which may be an access point (AP) or non-AP device. The OOB mechanism may include various radio access technologies (RATs), such as Bluetooth Low Energy (BLE), 802.11-based communications (e.g., WiFi), and Ethernet, as illustrative, non-limiting examples.

However, there may be several issues associated with configuring UWB using OOB mechanisms. One issue, for example, may involve determining which AP among multiple APs deployed within a network will perform the OOB configuration to enable UWB. Another issue is that, even when an AP is designated to deliver the OOB configuration, the AP's radios may be busy with a connection with other devices, meaning the AP may have to use an alternate mechanism to perform the OOB configuration. Yet another issue is that, when using an GOB mechanism for UWB configuration to a device, such as an asset tag, it may be important to discover all tags, decide which AP can make a BLE connection to the tag (e.g., multiple APs may be able to see the tag), and configure the tag GOB. Additionally, another issue involves determining which mechanism should be used for authentication during the GOB communication.

Certain embodiments described herein provide techniques for enabling UWB configuration using GOB mechanisms, such as BLE, WiFi, and Ethernet, as illustrative examples. As described in greater detail below, various GOB UWB discovery and configuration techniques are provided. In certain embodiments, the GOB UWB discovery and configuration technique may involve using certain WiFi protocols (e.g., generic advertisement service (GAS), access network query protocol (ANQP), among others) during pre-association (e.g., prior to association with an AP) to perform the GOB configuration. In certain other embodiments, the GOB UWB discovery and configuration technique may involve using BLE mechanisms to perform the GOB configuration. Advantageously, embodiments described herein may allow for dynamically pre-configure wireless devices with the UWB capabilities of a network, enabling the wireless device to utilize UWB ranging for precise real-time measurement of location and distance.

Although the terms “first,” “second,” “third,” etc., may be used herein to describe various devices, circuits, elements, components, regions, layers and/or sections, these devices, circuits, elements, components, regions, layers and/or sections should not be limited by these terms. These terms may be only used to distinguish one device, circuit, element, component, region, layer or section from another device, circuit, element, component, region, layer, or section. Terms such as “first,” “second,” and other numerical terms, when used herein, do not imply a sequence or order unless clearly indicated by the context. Thus, a first device, circuit, element, component, region, layer, or section discussed herein could be termed a second device, circuit, element, component, region, layer, or section without departing from various embodiments described herein.

Note, the techniques described herein for performing UWB configuration using OOB mechanisms may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP or a controller. In some other implementations, a wireless node may include a client station (STA). In yet some other implementations, a wireless node may include a server (e.g., location server).

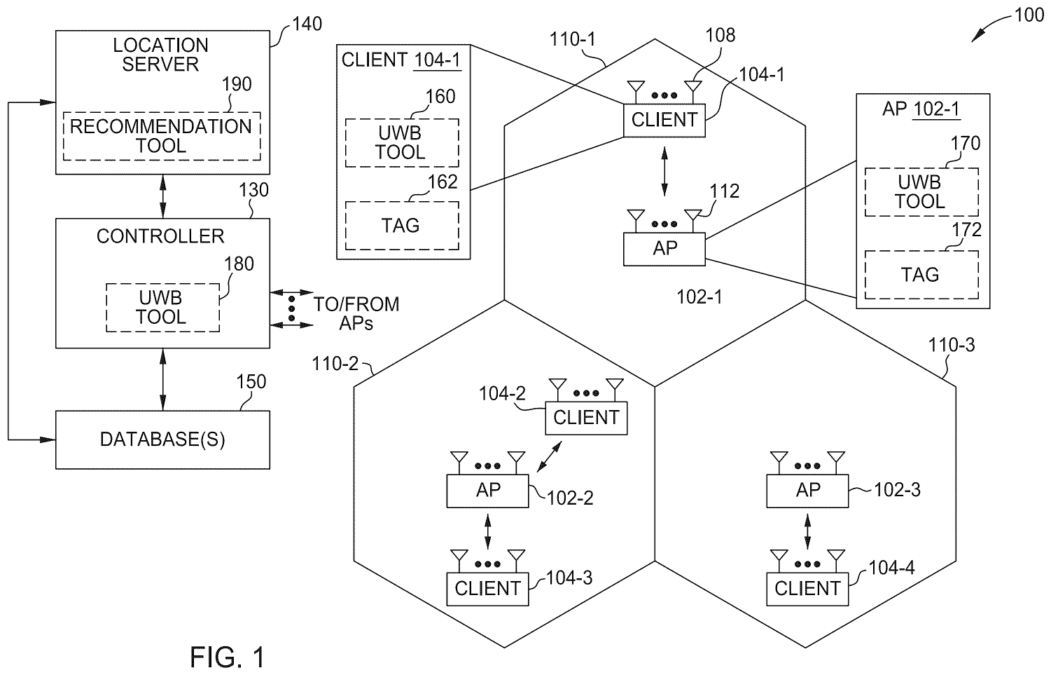

FIG. 1 illustrates an example system 100 in which one or more techniques described herein can be implemented, according to one embodiment. As shown, the system 100 includes, without limitation, one or more APs (e.g., AP 102-1, AP 102-2, and AP 102-3), one or more client STAs (e.g., client STA 104-1, client STA 104-2, client STA 104-3, and client STA 104-4), a controller 130, a location server 140, and one or more databases 150.

An AP is generally a fixed station that communicates with client STA(s) and may be referred to as a base station, wireless device, or some other terminology. A client STA may be fixed or mobile and also may be referred to as a mobile STA, a client, a STA, a wireless device, or some other terminology. Note that while a certain number of APs and client STAs are depicted, the system 100 may include any number of APs and client STAs.

As used herein, an AP along with the STAs associated with the AP (e.g., within the coverage area (or cell) of the AP) may be referred to as a basic service set (BSS). Here, AP 102-1 is the serving AP for client STA 104-1, AP 102-2 is the serving AP for client STAs 104-2 and 104-3, and AP 102-3 is the serving AP for client STA 104-4. The AP 102-1, AP 102-2, and AP 102-3 are neighboring (peer) APs. The APs 102 may communicate with one or more client STAs 104 on the downlink and uplink. The downlink (e.g., forward link) is the communication link from the AP 102 to the client STA(s) 104, and the uplink (e.g., reverse link) is the communication link from the client STA(s) 104 to the AP 102. In some cases, a client STA may also communicate peer-to-peer with another client STA.

As shown in FIG. 1, each client STA 104 includes one or more radios 108. The client STA 104 can use one or more of the radios 108 to form links with an AP 102. As also shown, each AP 102 includes one or more radios 112 that the AP 102 can use to form links with one or more client STAs 104 and/or one or more APs 102. In general, the AP(s) 102 and the client STA(s) 104 may form any suitable number of links for communication using any suitable frequencies and using any suitable communication protocols. In some instances, a client STA 104 may form multiple links with a single AP 102. In some cases, the AP 102 may use at least one radio 112 to communicate with at least one radio 112 of another AP 102 using a UWB communication protocol. For example, the respective radios 112 of the APs may be UWB radios. The APs may use their respective UWB radios to exchange UWB signals with each other, e.g., according to the UWB communication protocol. Additionally, in some cases, the AP 102 may use at least one radio 112 to communicate with at least one radio 112 of another AP 102 and/or a controller 130 using a non-UWB communication protocol, such as WiFi, Bluetooth, cellular, etc.

In certain embodiments, the APs 102 may be controlled or managed at least partially by the controller 130. Here, the controller 130 couples to and provides coordination and control for the APs 102 1-3. For example, the controller 130 may handle adjustments to RF power, channels, authentication, and security for the APs. The controller 130 may also coordinate the links formed by the client STA(s) 104 with the APs 102. The controller 130 and APs 102 may utilize a same control plane protocol.

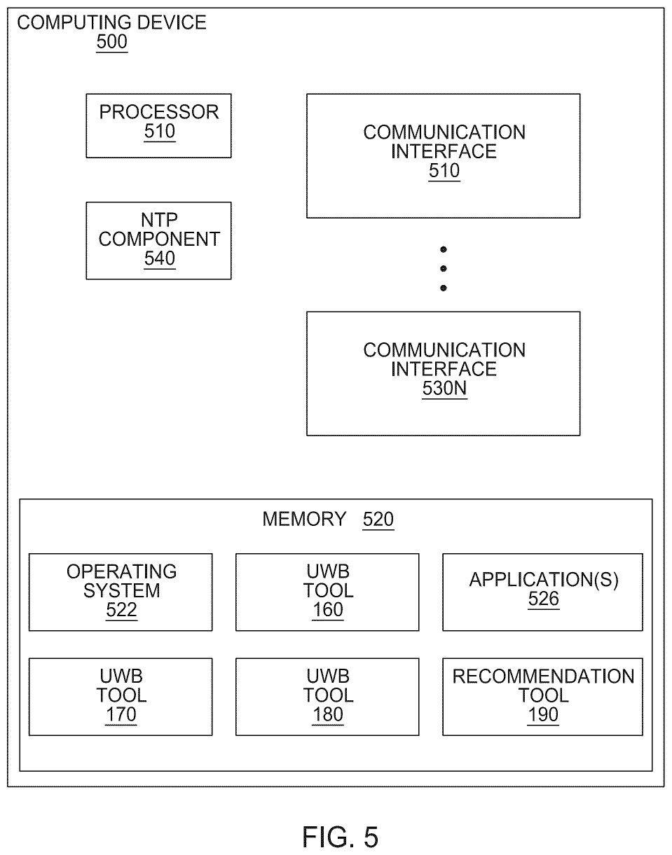

The operations of the controller 130 may be implemented by any device or system, and may be combined or distributed across any number of systems. For example, the controller 130 may be a wireless local area network (WLAN) controller for the deployment of APs 102 within the system 100. In some examples, the controller 130 is included within or integrated with an AP 102 and coordinates the links formed by that AP 102 (or otherwise provides control for that AP). For example, each AP 102 may include a controller that provides control for that AP. In some examples, the controller 130 is separate from the APs 102 and provides control for those APs. In FIG. 1, for example, the controller 130 may communicate with the APs 102 1-3 via a (wired or wireless) backhaul. The APs 102 1-3 may also communicate with one another, e.g., directly or indirectly via a wireless or wireline backhaul. Example hardware that may be included in an AP 102, a controller 130, or a client STA 104 is discussed in greater detail with regard to FIG. 5.

The location server 140 is generally representative of a server or system that uses a variety of technologies to track the location of devices or objects in real-time. In one embodiment, the location server 140 is a real-time location server (RTLS). In certain embodiments, the location server 140 may use UWB technology to determine the location of devices in real-time. For example, the location server 140 may use a network of receivers (e.g., anchors) to pick up signals from wireless devices (e.g., UWB tags) within a network. The location server 140 may determine the location of a given wireless device based on the signals and convey an indication of the location to the wireless device.

The database(s) 150 are representative of storage systems that may include, without limitation, historical and/or real-time client STA telemetry data, UWB parameters, time-of-flight (ToF) information (e.g., signal transmission times, reception times, and reply times), radio resource configurations (e.g., AP maximum transmit powers), radio resource management (RRM) information, among other information.

In certain cases, one or more devices depicted in FIG. 1 may perform one or more UWB positioning techniques to determine precise measurements of location and/or distance. As an illustrative example, a client STA 104-1 may include an UWB tag 162 (e.g., initiator) and one or more APs 102 (e.g., AP 102-1) may include an UWB anchor 172 (e.g., responder). The client STA 104-1 and AP 102-1 may participate in a UWB ranging procedure, where the client STA 104-1 and AP 102-1 pass UWB signals back and forth via the respective UWB tag 162 and UWB anchor 172, keeping track of signal transmission times, reception times, and reply times, in order to determine the precise distance between themselves.

In certain embodiments, one or more of the devices in the system 100 may include a respective UWB tool that is configured to perform one or more techniques described herein for configuring UWB using OOB mechanisms. As shown, the client STA 104-1 includes a UWB tool 160, the AP 102-1 includes a UWB tool 170, and the controller 130 includes a UWB tool 180. The UWB tools 160, 170, and 180 may include hardware, software, firmware, or combinations thereof.

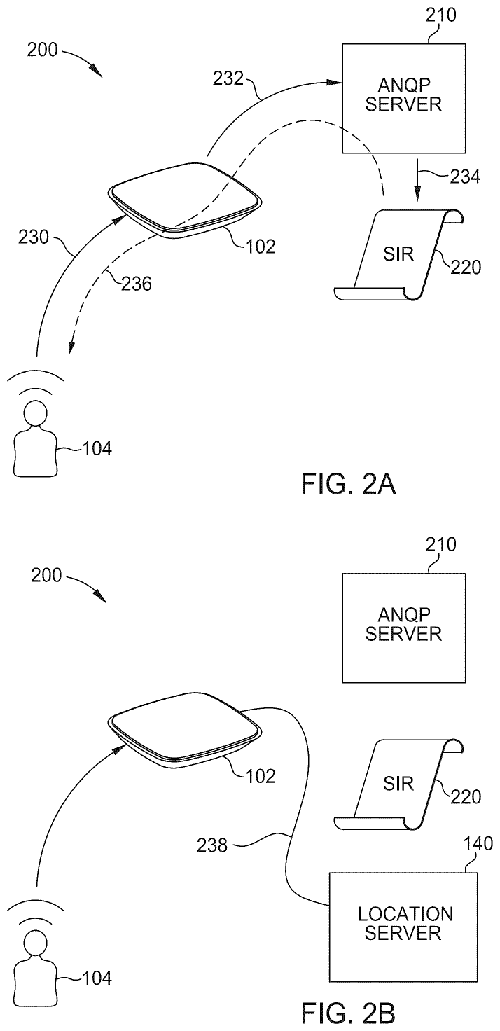

In certain embodiments, the UWB tools 160, 170, and 180 may perform an OOB UWB discovery and configuration technique using WiFi. By way of example, FIGS. 2A-2B depict an example scenario 200 for performing an OOB UWB discovery and configuration using WiFi, according to certain embodiments.

In certain embodiments, the scenario 200 depicted in FIGS. 2A-2B is an illustrative example of performing an OOB UWB discovery and configuration over WiFi during pre-association (e.g., prior to the client STA 104 associating with the AP 102). For example, certain wireless systems (e.g., IEEE 802.11u) may allow a mobile device to have a dialog with Wi-Fi infrastructure devices (e.g., APs 102 and/or controller 130) at pre-association. This pre-association function allows client STAs 104 to determine which capabilities a Wi-Fi network supports. The protocols used by 802.11u, for example, may include the generic advertisement service (GAS) and the access network query protocol (ANQP).

In addition, certain wireless systems (e.g., IEEE 802.11aq) may allow devices to determine which services in the wireless network (e.g., WLAN) are available prior to connecting to the wireless network (known as pre-association discovery (PAD)). 802.11 aq specifies parameters for pre-association queries between wireless networks and devices and facilitates an exchange of information between the AP 102 and client STAs 104.

Certain embodiments herein use various WiFi pre-association protocols, such as PAD (e.g., 802.11aq), GAS and ANQP (e.g., 802.11u), among others, to support UWB ranging capability exchange and parameter establishment. With reference to FIG. 2A, as illustrated at 230, the client STA 104 uses ANQP to query the network for information on UWB capabilities of the network. For example, the client STA 104 may transmit an ANQP request message to the AP 102 over a communication link (e.g., WiFi communication link) between the client STA 104 and AP 102.

As illustrated at 232, the AP 102 may query an ANQP server 210 in the network in response to receiving the ANQP request message from the client STA 104. The ANQP server 210 is generally configured to interact with a service information registry (SIR) 220, which has a record of available services in the network. In certain embodiments herein, UWB ranging capabilities are added to the SIR 220. For example, available services (including UWB ranging capabilities) in the wireless network are registered within the SIR 220, so that client STAs 104 using PAD can query the SIR 220 to determine which services are available. Note, the service announcement can be broadcast or unicast, and unsolicited or on-demand.

As illustrated at 234 in FIG. 2A, the ANQP server 210 may query the SIR 220 for the UWB capability information. Upon receiving the UWB capability information, the ANQP server 210 may provide the UWB capability information to the client STA 104, e.g., via the AP 102. For example, as illustrated at 236, the UWB capability information is relayed back to the client STA 104 via the communication link (e.g., WiFi communication link) between the client STA 104 and AP 102. For instance, the AP 102 may transmit, to the client STA 104, an ANQP response message including the UWB capability information.

Note, while FIG. 2A depicts the client STA 104 using ANQP to query the network for UWB capability information, in certain embodiments, the AP 102 may be configured to advertise the UWB capability information to the client STA 104 using 802.11u GAS frames. That is, the client STA 104 may receive an indication of the UWB capability information from the AP 102 without having to transmit an ANQP request message.

In certain embodiments, the UWB capability information may include at least one of information associated with a location server 140 or UWB capabilities of the network. For example, the UWB capability information may indicate whether the network supports UWB, an identifier of the location server 140, and/or information on how to connect to the location server 140, among other information.

In certain embodiments, the client device 104 may use the UWB capability information to connect to the location server 140 so that the UWB radios of the client STA 104 can be configured OOB. As illustrated at 238 in FIG. 2B, once the client STA 104 is configured with the details of the location server 140 via ANQP or GAS, the client STA 104 can communicate directly with the location server 140 (via the AP 102) to obtain a UWB configuration via the communication link (e.g., WiFi communication link) between the client STA 104 and the AP 102. For example, the location server 140 may provide the client STA 104 with UWB configuration information, which includes at least one of a ranging schedule for a UWB ranging session, a channel allocated for the UWB ranging session, a modulation to be used for the UWB ranging session, an indication of a UWB ranging mode for the UWB ranging session, or an indication of one or more UWB anchors (e.g., UWB anchors 172) in the network.

Note, in certain embodiments, as opposed to the ANQP exchange occurring prior to association, the ANQP exchange may occur after association. In such embodiments, after the client STA 104 is identified (e.g., device identification phase), the AP 102 may determine whether the client STA 104 is included within a subset of devices that is entitled to UWB location services. If so, the AP 102 may obtain UWB capability information from the SIR 220, e.g., via the ANQP server 210. In some cases, these embodiments may be adapted to environments where selective location is in place (e.g. areas of a hospital not accessible to the general public, but accessible to contractors). Additionally or alternatively, in certain embodiments, the device identification is used to select the parameters returned by the SIR 220. In an illustrative example, client STAs associated with the general public may obtain rough anchor location information, while client STAs associated with staff may obtain very accurate anchor location information. Similarly, in some cases, the timer exchanges performed by the UWB anchors may see their time encrypted. In such cases, the SIR 220 provides a particular key to the client STA depending on the device identification. For example, client STAs associated with the general public may obtain a general public key allowing the client STA to decrypt the time value to a certain accuracy, while client STAs associated with staff may obtain a staff key allowing the client STA to decrypt the time value to a further accuracy level.

In certain embodiments, as opposed to using an ANQP exchange to obtain UWB capability information, the AP 102 may advertise UWB capability information to the client STA 104 using beacon and/or probe response messages.

Referring back to FIG. 1, in certain embodiments, the UWB tools 160, 170, and 180 may perform an OOB UWB discovery and configuration technique using Bluetooth, such as BLE. In such embodiments, the client STA 104 may discover one or more APs 102 (e.g., UWB infrastructure devices) in a vicinity of the client STA 104 using a known (pre-established) BLE advertising channel (e.g., similar to an advertising beacon that informs others in the area that the AP is UWB capable). When the client STA 104 (e.g., UWB tag 162) responds via BLE that it is UWB capable, the AP 102 may attempt to connect to the client STA 104 and send the client STA 104 UWB capability information.

In certain other embodiments, the client STA 104 may detect a BLE beacon suggesting UWB capabilities. Here, the client STA 104 may directly initiate a connection with the AP 102 in order to obtain the UWB capability information. Note, in such embodiments, the client STA 104 may observe several UWB capable APs in the vicinity, but may choose the AP 102 that is closest to the client STA 104 (e.g., based on a signal strength of the AP at the client STA). Once the connection is made, the location server 140 may configure the client STA 104 with UWB configuration information via the BLE connection between the client STA 104 and the AP 102.

Note, in various embodiments described herein, the UWB configuration information provided to the client STA 104 from the location server 140 may include an entire set of UWB parameters (e.g., channel, modulation, etc.) or a partial list and a label for known parameters. For example, FiRA or other organizations may define default channels and parameters. In such cases, as opposed to providing the default parameters, the location server 140 may include a label (e.g., FiRA default mode 2) associated with the default parameters, and include the parameters that are included within the default set of parameters and/or parameters that deviate from the default set of parameters.

Certain embodiments described herein also provide techniques for optimizing (or at least improving) the transmission of UWB capability information via OOB mechanisms. For example, compared to WiFi and other technologies, a UWB radio may consume a significant amount of energy. As such, certain wireless devices may keep their UWB radio(s) disabled until the UWB stack is triggered (e.g., via an operating system (OS) trigger). In some cases, the UWB stack may be triggered when the user attempts to share a file as part of peer-to-peer (P2P) ranging and/or when using an application that relies on high accuracy relative positioning to another wireless device, as illustrative examples.

For certain indoor navigation applications, however, the OS trigger for UWB may be less obvious. For example, there are many locations where WiFi is available, but not UWB. For example, in certain indoor locations, WiFi range may be significantly larger than that of UWB, leading wireless devices to enable a UWB radio(s) without the ability to use the UWB radio(s) for ranging. Therefore, enabling the UWB radio each time the user needs navigation services and/or asset tracking in indoor locations may waste resources.

Additionally, while UWB ranging can be performed in multiple different UWB modes (e.g., TWR, TDoA, and hybrid mode), the particular mode that is used depends on the number of anchors available in the network. For example, with TWR, a client STA may exchange several messages with a single anchor in order to establish the client STA's distance to the anchor. In TDoA, on the other hand, the client STA may listen and hear synchronization messages exchanged between multiple anchors. The client STA may then use the TDoA between the different messages to deduce its relative proximity to one anchor vs. another. Thus, this UWB mode may work if the client STA can hear at least 3 anchors (2D localization) or 4 anchors (3D localization). In a hybrid mode generally used with navigation and asset tracking, a client STA may send occasional messages (possibly with a randomized MAC address) to allow the UWB infrastructure to obtain traces of the device's path, without individual identification (or full device location for assets configured to use their real MAC address). Similar to TDoA, this mode may depend on the number of anchors available.

The wireless device, however, may lack awareness of the UWB mode that is available at a given location. Accordingly, it may be desirable to provide techniques for optimizing transmission of UWB capability information over OOB mechanisms (e.g., WiFi or BLE) to make the transmissions more efficient, matching the expected user experience (for UWB ranging) at the particular location of the wireless device.

Accordingly, certain embodiments provide techniques for augmenting the OOB communication of UWB capability information. Referring back to FIG. 1, the location server 140 may include a recommendation tool 190, which is configured to determine a signal strength (e.g., received signal strength indication (RSSI) boundary) at which UWB should be available and, based on the client STA's position, the UWB mode that is most likely to convey ranging success. The recommendation tool 190 may provide an indication of the signal strength boundary along with the recommended UWB mode to the AP, which provides the information to the client STA via the OOB communication.

In certain embodiments, the recommendation tool 190 may monitor exchanges of UWB ranging messages during one or more UWB ranging sessions and build a map of UWB availability within a network, based on the monitoring. For example, during a training phase, the recommendation tool 190 may monitor as one or more APs 102 announce UWB availability (e.g., UWB capability information) to one or more client STAs 104. Note, during the training phase, the APs 102 may indicate TWR as the supported UWB mode. When an announcement is made through unicast frames (e.g., probe responses, ANQP responses, etc.), the UWB infrastructure (e.g., location server 140, recommendation tool 190, etc.) may provide to each client STA 104 a different UWB MAC address for each anchor. The recommendation tool 190 may monitor the aforementioned exchanges and record, for each client STA, the following set of information {requesting client STA MAC address, provided anchor1 MAC address, . . . provided anchor N MAC address}.

Once client STA(s) have been configured with UWB configuration information, one or more of the client STAs may discover UWB availability and begin UWB ranging. Here, the training phase may further involve monitoring exchanges of ranging messages between client STAs 104 (tags) and APs 102 (anchors) within the network. In some cases, a UWB ranging procedure may not be completed (e.g., the client STA may hear the OOB announcements, but may be out of range from the UWB anchor). In other cases, the UWB ranging procedure may be completed. In general, a UWB anchor may respond to any frame having a destination address that has previously communicated to a client STA, e.g., within UWB configuration information.

When an UWB anchor response to a client STA, the UWB anchor may provide to the location server 140 the destination MAC address that the client STA used. The location server 140 may then map the destination MAC address to the client STA, and trigger the AP 102 (associated with the UWB anchor that the client STA ranged against) to send a beacon request message (e.g., 802.11k beacon request) to the client STA. Upon receiving the beacon request message, the client STA 104 may send, to the location server 140, an indication of the RSSI of the AP's radio to which the UWB anchor is attached. Here, the location server 140 may record the RSSI as well as the STA's RSSI's on APs to which other anchors are attached and an indication of whether the STA either successfully ranged or did not successfully range against those other anchors.

The training phase may further involve using the aforementioned information to build a map of UWB availability within a given environment. For example, the recommendation tool 190 may use the RSSI(s) to build a map of UWB availability on a particular floor(s) of a building. For each AP 102, the recommendation tool 190 may generate a UWB boundary, which is representative of the WiFi RSSI at which the client STA should hear an AP in order to be in range of an UWB anchor. For each RSSI value included in the UWB boundary, the recommendation tool 190 may also determine the likelihood of the client STA to detect additional (e.g., second, third, and so on) anchors.

Once the UWB availability map is generated, the recommendation tool 190 may use the UWB availability map to augment the UWB capability information provided to the client STA via the OOB communication. For example, when providing the UWB capability information to the client STA 104 via the AP 102, the recommendation tool 190 may include an RSSI threshold, which indicates to the requesting client STA 104 the level at which the AP 102 should be heard before the client STA 104 would expect to detect the associated UWB anchor.

Additionally or alternatively, the recommendation tool 190 may indicate, via the AP 102, one or more UWB mode availability information elements (IEs). Each UWB mode availability IE may indicate which UWB mode is expected to be supported at the given client STA's location. For example, an UWB mode availability IE may indicate which UWB mode is expected at the cell edge (when UWB starts being usable), as well as which other modes are expected to be possible at other RSSI thresholds.

In certain embodiments, the recommendation tool 190 may continually update the UWB availability map, based on monitoring the UWB ranging within the network. For example, as the client STA queries the UWB infrastructure, the client STA may discover one or more RSSI thresholds, and start ranging accordingly. As the RSSI value(s) may be relative, it may be expected that the client STA may attempt to start ranging at an RSSI value slightly below the indicated RSSI threshold. In cases where the client STA uses TDoA, it may be invisible to the anchor (as the client STA passively listens). Thus, in these cases, the recommendation tool 190 may count the client STAs 104 (and their RSSI) that query for UWB and then subsequently become silent (as a result of not using UWB or using TDoA), count those client STAs that switch to TWR in a zone where TDoA was announced, count those client STAs that switch to TDoA in a zone where TWR was announced, and count those client STAs that use a hybrid UWB mode. The recommendation tool 190 may use this information to update the UWB availability map.

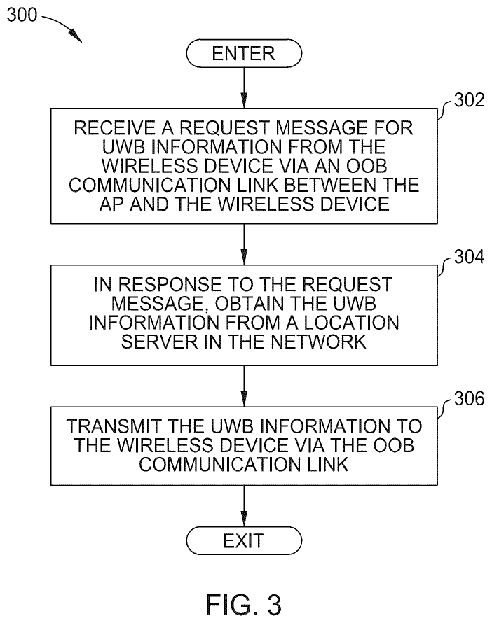

FIG. 3 is a flowchart of a method 300 for wireless communications, according to one embodiment. The method 300 may be performed by an AP, such as AP 102. In certain embodiments, the method 300 may be performed to enable an UWB configuration using an OOB mechanism, such as WiFi, for example.

Method 300 may enter at block 302, where the AP receives a request message for UWB information from the wireless device (e.g., client STA 104) via an OOB communication link (e.g., WiFi communication link) between the AP and the wireless device. In certain embodiments, the AP may receive the request message prior to an association with the wireless device. In certain embodiments, the AP may receive the request message after an association with the wireless device.

At block 304, the AP obtains the UWB information from a location server (e.g., location server 140) in the network in response to the request message.

At block 306, the AP transmits the UWB information to the wireless device via the OOB communication link.

In certain embodiments, the request message includes an ANQP request message. In such embodiments, the AP may transmit the UWB information (in block 306) within an ANQP response message.

In certain embodiments, the method 400 may further involve, in response to the request message, sending a query for the UWB information to the location server. In such embodiments, obtaining the UWB information may include receiving a response message including the UWB information from the location server.

In certain embodiments, the UWB information may include (i) an identifier of the location server, (ii) UWB capabilities of the network, (iii) a signal strength threshold of the AP associated with detection of one or more UWB anchors associated with the AP, (iv) one or more UWB mode availability information elements (IE), each UWB mode availability IE indicating a respective UWB ranging mode that is available at a respective signal strength threshold of the AP at the wireless device, or (v) any combination thereof.

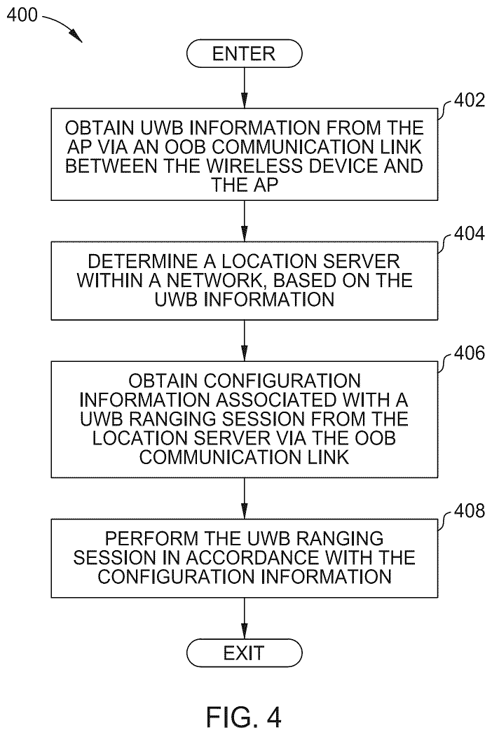

FIG. 4 is a flowchart of a method 400 for wireless communications, according to one embodiment. The method 400 may be performed by a wireless device, such as a client STA (e.g., client STA 104). In certain embodiments, the method 400 may be performed to enable an UWB configuration using an OOB mechanism, such as WiFi, for example.

Method 400 may enter at block 402, where the wireless device obtains UWB information from the AP via an OOB communication link between the wireless device and the AP. In certain embodiments, the wireless device obtains the UWB information prior to an association with the AP. In certain embodiments, the wireless device obtains the UWB information after an association with the AP.

At block 404, the wireless device determines a location server within a network, based on the UWB information.

At block 406, the wireless device obtains configuration information associated with a UWB ranging session from the location server via the OOB communication link.

At block 408, the wireless device performs the UWB ranging session in accordance with the configuration information.

In certain embodiments, the method 400 further involves transmitting, to the AP via the GOB communication link, a request message for the UWB information prior to the association with the AP. In such embodiments, obtaining the UWB information may include receiving, from the AP via the GOB communication link, a response message including the UWB information. The request message may include an access network query protocol (ANQP) request message, and the response message may include an ANQP response message.

In certain embodiments, obtaining the UWB information (at block 402) may include receiving, from the AP via the GOB communication link, one or more advertisement messages including the UWB information. The one or more advertisement messages may include GAS frames.

In certain embodiments, obtaining the UWB information (at block 402) may include receiving, from the AP via the OOB communication link, at least one of a beacon message or a probe response message including the UWB information.

In certain embodiments, the configuration information may include at least one of a ranging schedule for the UWB ranging session, a channel allocated for the UWB ranging session, a modulation to be used for the UWB ranging session, an indication of a UWB ranging mode for the UWB ranging session, or an indication of one or more UWB anchors in the network. The indication of the one or more UWB anchors may include a respective UWB media access control (MAC) address for each of the one or more UWB anchors.

In certain embodiments, performing the UWB ranging session (at block 408) may include: (i) transmitting a ranging message to a first UWB anchor of the one or more UWB anchors, the first UWB anchor being associated with the AP; (ii) receiving a beacon request message from the AP after transmitting the ranging message; and (iii) in response to the beacon request message, transmitting a message comprising an indication of a signal strength of the AP to the location server.

In certain embodiments, the UWB information may include (i) an identifier of the location server, (ii) UWB capabilities of the network, (iii) a signal strength threshold of the AP associated with detection of one or more UWB anchors associated with the AP, (iv) one or more UWB mode availability information elements (IE), each UWB mode availability IE indicating a respective UWB ranging mode that is available at a respective signal strength threshold of the AP at the wireless device, or (v) any combination thereof.

FIG. 5 illustrates an example computing device 500, according to one embodiment. The computing device 500 can be configured to perform one or more techniques described herein for configuring UWB configuration using OOB mechanisms. For example, the computing device 500 can perform method 300, method 400, and any other techniques (or combination of techniques) described herein. The computing device 500 may be representative of a controller (e.g., controller 130), a network entity (e.g., an AP, such as AP 102), a server (e.g., location server 140), or a wireless device (e.g., client STA 104). The computing device 500 includes, without limitation, a processor 510, a memory 520, an NTP component 540 (e.g., configured to interact with an NTP server (not shown)), and one or more communication interfaces 530a-n (generally, communication interface 530). In one example, the communication interface 530 includes a radio. In certain embodiments, at least one of the communication interfaces includes a UWB radio. Additionally or alternatively, at least one of the communication interfaces may support an OOB communication protocol, such as WiFi, cellular, Bluetooth, Ethernet, etc.

The processor 510 may be any processing element capable of performing the functions described herein. The processor 510 represents a single processor, multiple processors, a processor with multiple cores, and combinations thereof. The communication interfaces 530 (e.g., radios) facilitate communications between the computing device 500 and other devices. The communications interfaces 530 are representative of wireless communications antennas and various wired communication ports.

The memory 520 may be either volatile or non-volatile memory and may include RAM, flash, cache, disk drives, and other computer readable memory storage devices. Although shown as a single entity, the memory 520 may be divided into different memory storage elements such as RAM and one or more hard disk drives. As shown, the memory 520 includes various instructions that are executable by the processor 510 to provide an operating system 522 to manage various functions of the computing device 500. The memory 520 also includes UWB tools 160, 170, and 180, one or more application(s) 526, and recommendation tool 190.

The computing device 500 may include storage (not shown). In some cases, the storage may be a disk drive or flash storage device. In some cases, the storage may be a combination of fixed and/or removable storage devices, such as fixed disc drives, solid state drives, removable memory cards, optical storage, network attached storage (NAS), or a storage area-network (SAN). The storage may include ToF information, distance information, ranging reports, ranging parameters, or any combination thereof, as illustrative, non-limiting examples.

### EXAMPLE CLAUSES

In addition to the various embodiments described above, certain example embodiments are within the scope of the disclosure, some of which are detailed below:

Clause 1: A method for wireless communications performed by a wireless device, comprising: obtaining, prior to association with an access point (AP), ultra-wideband (UWB) information from the AP via an out-of-band (OOB) communication link between the wireless device and the AP; determining a location server within a network comprising the wireless device and the AP, based on the UWB information; obtaining configuration information associated with a UWB ranging session from the location server via the OOB communication link; and performing the UWB ranging session in accordance with the configuration information.

Clause 2: The method of Clause 1, further comprising transmitting, to the AP via the OOB communication link, a request message for the UWB information prior to the association with the AP, wherein obtaining the UWB information comprises receiving, from the AP via the GOB communication link, a response message comprising the UWB information.

Clause 3: The method of Clause 2, wherein: the request message comprises an access network query protocol (ANQP) request message; and the response message comprises an ANQP response message.

Clause 4: The method of Clause 1, wherein obtaining the UWB information comprises receiving, from the AP via the GOB communication link, one or more advertisement messages comprising the UWB information.

Clause 5: The method of Clause 4, wherein the one or more advertisement messages comprise generic advertisement service (GAS) frames.

Clause 6: The method of Clause 1, wherein obtaining the UWB information comprises receiving, from the AP via the OOB communication link, at least one of a beacon message or a probe response message comprising the UWB information.

Clause 7: The method of any of Clauses 1-6, wherein the UWB information comprises at least one of an identifier of the location server or UWB capabilities of the network.

Clause 8: The method of any of Clauses 1-7, wherein the configuration information comprises at least one of a ranging schedule for the UWB ranging session, a channel allocated for the UWB ranging session, a modulation to be used for the UWB ranging session, an indication of a UWB ranging mode for the UWB ranging session, or an indication of one or more UWB anchors in the network.

Clause 9: The method of Clause 8, wherein the indication of the one or more UWB anchors comprises a respective UWB media access control (MAC) address for each of the one or more UWB anchors.

Clause 10: The method of any of Clauses 8-9, wherein performing the UWB ranging session comprises: transmitting a ranging message to a first UWB anchor of the one or more UWB anchors, the first UWB anchor being associated with the AP; receiving a beacon request message from the AP after transmitting the ranging message; and in response to the beacon request message, transmitting a message comprising an indication of a signal strength of the AP to the location server.

Clause 11: The method of any of Clauses 1-10, wherein the UWB information comprises a signal strength threshold of the AP associated with detection of one or more UWB anchors associated with the AP.

Clause 12: The method of Clause 11, wherein the UWB information further comprises one or more UWB mode availability information elements (IE), each UWB mode availability IE indicating a respective UWB ranging mode that is available at a respective signal strength threshold of the AP at the wireless device.

Clause 13: The method of any of Clauses 1-12, wherein the OOB communication link is an 802.11 communication link.

Clause 14: A method for wireless communications performed by an access point (AP), comprising: receiving, prior to association with a wireless device, a request message for ultra-wideband (UWB) information from the wireless device via an out-of-band (OOB) communication link between the AP and the wireless device; in response to the request message, obtaining the UWB information from a location server in a network comprising the wireless device and the AP; and transmitting the UWB information to the wireless device via the OOB communication link.

Clause 15: The method of Clause 14, wherein: the request message comprises an access network query protocol (ANQP) request message; and transmitting the UWB information comprises transmitting an ANQP response message comprising the UWB information.

Clause 16: The method of any of Clauses 14-15, further comprising, in response to the request message, sending a query for the UWB information to the location server, wherein obtaining the UWB information comprises receiving a response message comprising the UWB information from the location server.

Clause 17: The method of any of Clauses 14-16, wherein the UWB information comprises at least one of an identifier of the location server or UWB capabilities of the network.

Clause 18: The method of any of Clauses 14-17, wherein the UWB information comprises a signal strength threshold of the AP associated with detection of one or more UWB anchors associated with the AP.

Clause 19: The method of any of Clauses 14-18, wherein the UWB information further comprises one or more UWB mode availability information elements (IE), each UWB mode availability IE indicating a respective UWB ranging mode that is available at a respective signal strength threshold of the AP at the wireless device.

Clause 20: A wireless device comprising: one or more memories collectively storing instructions; and one or more processors communicatively coupled to the one or more memories, the one or more processors being individually or collectively configured to execute the instructions to cause the wireless device to perform an operation comprising: obtaining, prior to association with an access point (AP), ultra-wideband (UWB) information from the AP via an out-of-band (OOB) communication link between the wireless device and the AP; determining a location server within a network comprising the wireless device and the AP, based on the UWB information; obtaining configuration information associated with a UWB ranging session from the location server via the OOB communication link; and performing the UWB ranging session in accordance with the configuration information.

Clause 21: A computing device comprising: one or more memories collectively storing instructions; and one or more processors communicatively coupled to the one or more memories, the one or more processors being collectively configured to execute the instructions to cause the computing device to perform a method in accordance with any of Clauses 1-13.

Clause 22: An apparatus, comprising means for performing a method in accordance with any of Clauses 1-13.

Clause 23: A non-transitory computer-readable medium storing executable instructions that, when executed by one or more processors of a computing device, cause the computing device to perform a method in accordance with any of Clauses 1-13.

Clause 24: A computing device comprising: one or more memories collectively storing instructions; and one or more processors communicatively coupled to the one or more memories, the one or more processors being collectively configured to execute the instructions to cause the computing device to perform a method in accordance with any of Clauses 14-19.

Clause 25: An apparatus, comprising means for performing a method in accordance with any of Clauses 14-19.

Clause 26: A non-transitory computer-readable medium storing executable instructions that, when executed by one or more processors of a computing device, cause the computing device to perform a method in accordance with any of Clauses 14-19.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for wireless communications performed by a wireless device, comprising:
obtaining, prior to association with an access point (AP), ultra-wideband (UWB) information from the AP via an out-of-band (OOB) communication link between the wireless device and the AP;
determining a location server within a network comprising the wireless device and the AP, based on the UWB information;
obtaining configuration information associated with a UWB ranging session from the location server via the OOB communication link; and
performing the UWB ranging session in accordance with the configuration information.

2. The method of claim 1, further comprising transmitting, to the AP via the OOB communication link, a request message for the UWB information prior to the association with the AP, wherein obtaining the UWB information comprises receiving, from the AP via the GOB communication link, a response message comprising the UWB information.

3. The method of claim 2, wherein:
the request message comprises an access network query protocol (ANQP) request message; and
the response message comprises an ANQP response message.

4. The method of claim 1, wherein obtaining the UWB information comprises receiving, from the AP via the GOB communication link, one or more advertisement messages comprising the UWB information.

5. The method of claim 4, wherein the one or more advertisement messages comprise generic advertisement service (GAS) frames.

6. The method of claim 1, wherein obtaining the UWB information comprises receiving, from the AP via the OOB communication link, at least one of a beacon message or a probe response message comprising the UWB information.

7. The method of claim 1, wherein the UWB information comprises at least one of an identifier of the location server or UWB capabilities of the network.

8. The method of claim 1, wherein the configuration information comprises at least one of a ranging schedule for the UWB ranging session, a channel allocated for the UWB ranging session, a modulation to be used for the UWB ranging session, an indication of a UWB ranging mode for the UWB ranging session, or an indication of one or more UWB anchors in the network.

9. The method of claim 8, wherein the indication of the one or more UWB anchors comprises a respective UWB media access control (MAC) address for each of the one or more UWB anchors.

10. The method of claim 9, wherein performing the UWB ranging session comprises:
transmitting a ranging message to a first UWB anchor of the one or more UWB anchors, the first UWB anchor being associated with the AP;
receiving a beacon request message from the AP after transmitting the ranging message; and
in response to the beacon request message, transmitting a message comprising an indication of a signal strength of the AP to the location server.

11. The method of claim 1, wherein the UWB information comprises a signal strength threshold of the AP associated with detection of one or more UWB anchors associated with the AP.

12. The method of claim 11, wherein the UWB information further comprises one or more UWB mode availability information elements (IE), each UWB mode availability IE indicating a respective UWB ranging mode that is available at a respective signal strength threshold of the AP at the wireless device.

13. The method of claim 1, wherein the OOB communication link is an 802.11 communication link.

14. A method for wireless communications performed by an access point (AP), comprising:
receiving, prior to association with a wireless device, a request message for ultra-wideband (UWB) information from the wireless device via an out-of-band (OOB) communication link between the AP and the wireless device;
in response to the request message, obtaining the UWB information from a location server in a network comprising the wireless device and the AP; and
transmitting the UWB information to the wireless device via the OOB communication link.

15. The method of claim 14, wherein:
the request message comprises an access network query protocol (ANQP) request message; and
transmitting the UWB information comprises transmitting an ANQP response message comprising the UWB information.

16. The method of claim 14, further comprising, in response to the request message, sending a query for the UWB information to the location server, wherein obtaining the UWB information comprises receiving a response message comprising the UWB information from the location server.

17. The method of claim 14, wherein the UWB information comprises at least one of an identifier of the location server or UWB capabilities of the network.

18. The method of claim 14, wherein the UWB information comprises a signal strength threshold of the AP associated with detection of one or more UWB anchors associated with the AP.

19. The method of claim 18, wherein the UWB information further comprises one or more UWB mode availability information elements (IE), each UWB mode availability IE indicating a respective UWB ranging mode that is available at a respective signal strength threshold of the AP at the wireless device.

20. A wireless device comprising:
one or more memories collectively storing instructions; and
one or more processors communicatively coupled to the one or more memories, the one or more processors being individually or collectively configured to execute the instructions to cause the wireless device to perform an operation comprising:
obtaining, prior to association with an access point (AP), ultra-wideband (UWB) information from the AP via an out-of-band (OOB) communication link between the wireless device and the AP;
determining a location server within a network comprising the wireless device and the AP, based on the UWB information;
obtaining configuration information associated with a UWB ranging session from the location server via the OOB communication link; and
performing the UWB ranging session in accordance with the configuration information.
